(19) United States
(12) Patent Application Publication
(10) Pub. No.: US 2019/0007308 A1
(43) Pub. Date: Jan. 3, 2019

(54) DISTRIBUTED TRAFFIC MANAGEMENT SYSTEM FOR NETWORK LINK BANDWIDTH CONTROL

(71) Applicant: MICROSOFT TECHNOLOGY LICENSING, LLC, Redmond, WA (US)

(72) Inventors: Debarghya MANDAL, Woodinville, WA (US); Mehmet TATLICIOGLU, Kirkland, WA (US); Nicholas Leonard HOLT, Seattle, WA (US); Daniel P. GICKLHORN, Bellevue, WA (US); Dhrubajyoti SAHA, Seattle, WA (US); Ravikumar ARUNACHALAM, Redmond, WA (US)

(21) Appl. No.: 15/638,990

(22) Filed: Jun. 30, 2017

(51) Int. Cl. H04L 12/721; H04L 12/801; H04L 12/741; H04L 12/715

(52) U.S. Cl. CPC H04L 45/44; H04L 47/10; H04L 45/58; H04L 45/04; H04L 45/745

(57) ABSTRACT

In various embodiments, methods and systems for implementing distributed traffic management are provided. A data request from a content server is accessed using a content serving agent. The data request is determined to be associated with a corresponding network link based on referencing an exterior protocol topology file. The exterior gateway protocol topology file includes a mapping of Internet Protocol (IP) prefixes to corresponding router-network-link identifiers indicating a router interface. A router-network-link identifier and one or more local control actions for the data request are identified using the control output file that includes a mapping between the router-network-link identifier and the one or more local control actions. Utilization data for the router-network-link identifier is accessed using the utilization data file. The utilization data is determined to be associated with executing one or more local control actions. The one or more local control actions associated with transmitting the data request are executed.

### BACKGROUND

A distributed (cloud) computing service provider or telecommunications service provider can implement a Content Delivery Network (CDN). A CDN can generally refer to a distributed network of servers in data centers to serve content to end-users. A CDN can be used to deliver high volumes of data to end-users outside of the distributed computing service provider network or outside of the telecommunications service provider network using networking links. For example, a CDN using a link, between the CDN and an end-user computing device outside of the CDN can provide content, content updates and patches to content used by the end-user. As such, a comprehensive traffic management system can be implemented for improved management of data traffic flows between content serving computing devices and end-user computing devices in CDNs.

### SUMMARY

Embodiments described herein are directed to methods, systems, and computer storage media for providing distributed traffic management for distributed network infrastructures. In particular, a distributed network infrastructure can be a content delivery network (CDN) that implements a distributed traffic management system. At a high level, the distributed traffic management system in the distributed network infrastructure is a de-centralized implementation of data traffic controls via network links connected to an external network infrastructure. The de-centralized implementation is based on a plurality of localized traffic management units serving corresponding portions of the distributed network infrastructure. A distributed traffic management system operates to collect, organize and process traffic management input data (e.g., routing data, utilization data and configuration data of border routers) from border routers corresponding to a specific traffic management unit to take appropriate local control actions. The local control actions support maintaining the bandwidth utilization of the network links associated with the border routers. The de-centralized implementation does not rely on a central traffic control system for the distributed network infrastructure. The distributed traffic management system includes a plurality of traffic management units in the distributed network infrastructure. A traffic management unit includes a monitoring agent, a controller agent, and a content serving agent for controlling traffic for a portion of the distributed network infrastructure.

In operation, the monitoring agent is configured to monitor a router interface to identify traffic management input data. The router interface includes a border router associated with a network link. The traffic management input data includes one or more of the following: routing data, utilization data, and configuration data associated with the border router. The monitor agent generates an exterior gateway protocol topology file based on the traffic management input data. The exterior gateway protocol topology file includes a mapping of Internet Protocol (IP) prefixes to router-network-link identifiers.

The router-network-link identifiers are accessed via a router interface file. The router interface file includes a plurality router-network-link identifiers, each router-network-link identifier corresponds to a router interface. The router interface has a router identifier and an outbound network link identifier as a single identifier defined using a hash function. The monitor agent also generates a utilization data file based on the traffic management input data. The utilization data file comprises a mapping of utilization data to router-network-link identifiers.

The distributed traffic management system further includes a controller agent configured to generate a control output file using the exterior protocol topology file and the utilization data file. The control output file comprises a mapping of router-network-link identifiers to one or more local control actions associated with control outputs to support maintaining a utilization threshold for router interfaces processing data requests.

The distributed traffic management system further includes a content serving agent configured to access a data request associated with a content server. The content serving agent determines, via an IP address associated with the data request, that the data request is associated with a corresponding network link, based on referencing the exterior protocol topology file. The content serving agent identifies a router-network-link identifier and one or more local control actions for the data request, based on accessing the control output file that comprises a mapping of router-network-link identifiers to one or more local control actions. Based on the control output file, the content serving agent determines whether to cause execution of the one or more local control actions associated with processing the data request.

In one embodiment, a traffic management unit can support a border router associated with two different sets of content servers (e.g., a first content server set and a second content server set) using the same egress network link. The first content server set is configured with a monitoring agent, controller agent and content serving agent, while the second content server set is an auxiliary content server set (e.g., non-local content server system or a non-supported content server system). The distributed traffic management system can operate to monitor the egress network link for utilization data attributable to both content server sets and implement a first set of local control actions on the first content server set and a second set of local control actions (e.g., informational communications) on the second content server set.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1A is a block diagram of an exemplary distributed network infrastructure having a distributed traffic management system, in accordance with embodiments described herein;

FIG. 1B is a block diagram of an exemplary distributed traffic management system having a plurality of traffic management units, in accordance with embodiments described herein;

FIG. 2 is a block diagram of an exemplary traffic management unit in a distributed traffic management system, in accordance with embodiments described herein;

FIG. 3 is a block diagram of an exemplary traffic management unit supporting two different content serving systems in a distributed traffic management system, in accordance with embodiments described herein;

FIG. 4 is a flow diagram showing an exemplary method for implementing a distributed traffic management system, in accordance with embodiments described herein;

FIG. 5 is a flow diagram showing an exemplary method for implementing a distributed traffic management system, in accordance with embodiments described herein; and

FIG. 6 is a block diagram of an exemplary computing environment suitable for use in implementing embodiments described herein.

### DETAILED DESCRIPTION

A distributed (cloud) computing service provider or telecommunications service provider can implement a Content Delivery Network (CDN). A CDN can generally refer to a distributed network of servers in data centers to serve content to end-users. A CDN can be used to deliver high volumes of data to end-users outside of the distributed computing service provider network or outside of the telecommunications service provider network using networking links. For example, a CDN using a link, between the CDN and an end-user computing device outside of the CDN can provide content, content updates and patches to content used by the end-user.

Content delivery network providers can face different types of challenges when attempting to transmit massive amounts of data to end-users in different Internet Protocol (IP) destinations. A CDN operates to transmit high volume data routed from the CDN's routers (e.g., border routers) internal to the network infrastructure of the CDN via a physical link (e.g., a peering link) of the router to an external network infrastructure (e.g., external border router). In particular, during high bandwidth usage times of the link, the link runs the risk of losing data due to the congestion on the link or degradation of hardware associated with link. For example, if the link is receiving data at or near the link's maximum data transfer rate, then the link runs the risk of losing current and additional data trying to be sent through the same link. In another example, if the link is currently receiving data at a rate near the bandwidth capacity of the link and a content update is trying to use the same link to update content to an end-user, then the link may be at risk of losing content update data packets due to the congestion of the link. Therefore, maintaining the bandwidth utilization at a predetermined utilization threshold of a link in order to reduce the potential loss of data on the link is essential.

Conventional networking solutions resolve network link congestion using different types of systems. For example, a CDN provider can implement a centralized system to manage the congestion on a network link. The centralized system uses a global central controller. The global central controller utilizes data collected from devices in the periphery of the network. The data collected from the devices is analyzed and a global snapshot in time of the system is created. The centralized system analyzes the global snapshot in time to make global traffic management decisions to alleviate network link. The global traffic management decisions are propagated back to and applied to the devices.

There are many problems with the conventional networking solution used to resolve network link congestion, where the centralized system manages the congestion on a network link. In particular, the conventional networking solution relies on a global central controller. The global central controller introduces a single point of failure for the conventional networking solution. Further, there is a potential inaccuracy due to the latency in collecting the data and applying the decisions based on the data. Specifically, the state of the devices in the periphery of the network can change between the time the data is collected, the time the data is analyzed, and the time the decisions based on the data is propagated back to and applied to the devices. Therefore, the data used from the global snapshot in time to make global traffic management decisions may not be the same data as the data from a global snapshot in time when the decisions are applied to the devices. Also, the maintenance and scalability of the devices may require changes to the global central controller. Thus, adding an unwanted dependence relationship between the devices and the global central controller. As such, a comprehensive traffic management system can be implemented for improved management of data traffic flows between content serving computers and end-user computers associated with CDNs.

Embodiments described herein provide simple and efficient methods and systems for providing distributed traffic management for a distributed network infrastructure. In particular, a distributed network infrastructure can be a content delivery network that implements a distributed traffic management system. The distributed traffic management system supports execution of one or more local control actions, within a traffic management unit, to support maintaining bandwidth utilization threshold associated with network links in the traffic management unit.

At a high level, the distributed traffic management system in the distributed network infrastructure is a de-centralized implementation of data traffic controls via network links connected to an external network infrastructure. The de-centralized implementation is based on a plurality of localized traffic management units serving corresponding portions of the distributed network infrastructure. A distributed traffic management system operates to collect, organize and process traffic management input data (e.g., routing data, utilization data and configuration data of border routers) from border routers corresponding to a specific traffic management unit to take appropriate local control actions to support maintaining the bandwidth utilization of the network links associated with the border routers. The de-centralized implementation does not rely on a central traffic control system for the distributed network infrastructure. The distributed traffic management system includes a plurality of traffic management units in the distributed network infrastructure. A traffic management unit includes a monitoring agent, a controller agent, and a content serving agent, for controlling traffic for a portion of the distributed network infrastructure.

Advantageously, the distributed traffic management implementation can protect the entire system as a whole from performance degradation by making locally optimal solutions. Moreover, this implementation supports increased agility of code deployment by localizing the effect of actions to a single environment. The distributed implementation also supports faster iterations of changes in that a negative change would not result in a global outage. The traffic management units operate as disparate systems working on their own to achieve the global performance goal.

Embodiments of the present disclosure can be described with reference to an exemplary distributed traffic management system for a distributed network infrastructure implementing a content delivery network to serve end-users data. The distributed traffic management system can include several localized traffic management units (e.g., point of presence—PoP), where each traffic management unit operates to support providing distributed, scalable, and fault tolerance mechanisms for traffic management. By way of example, a router (e.g., border router) at a particular traffic management unit can be linked to an outside network (e.g., external network infrastructure or Internet Service Provider (ISP)) using physical links that peer with non-internal routers. Such a link can be commonly referred to as a peering link. Peering link utilization can be gathered and analyzed in order to take appropriate local control actions at the corresponding traffic management unit. In particular, the local control actions can operate to protect against package losses and global outage. The distributed traffic management system implements each traffic management unit to take local control actions without global coordination, hence making actions more responsive, fault tolerant, and easier to deploy, and scale.

The distributed traffic management system operates to protect outbound links (e.g., egress network links) from over congestion in distributed fashion. Advantageously, not having a centralized system removes the problem of having a single point of failure. Making decisions that are only relevant to local environments ensures isolation and safeguards against code and deployment defect. Moreover, adding new environments can be done with little or no configuration changes and removes the risk of service interruptions or defects in a central service. Each traffic management unit to be added or removed is operationally self-contained (i.e., self-contained administrative control) and can be turned on or off at will without affecting other environments.

In operation, the traffic management unit can implement components that support maintaining the bandwidth utilization (e.g., a predetermined utilization threshold) of a network link based on a defined control output. In particular, the monitoring agent monitors and collects the data of the state of the routers in the distributed network infrastructure. For example, the monitoring agent monitors and collects data collectively referred to as traffic management input data (e.g., routing table data, link utilization data, and router internal configuration data) of the routers associated with the network. The different types of traffic management input data can be monitored and collected using a routing listener (e.g. BGP listener) and from network observer (e.g. SNMP) associated with the network.

The traffic management input data used to create different types of data structures (e.g., files, topology maps, tables, etc.) stored in file that can be accessed for implementing functionality of the distributed traffic management system. The monitoring agent also creates a Border Gateway Protocol topology map (i.e., exterior gateway protocol topology file). The monitoring agent, using the data from the state of the resources in the network, creates a mapping of IP prefixes to border router interfaces, where the IP prefix identifies a destination network for communicating data requested in a data request. The Border Gateway Protocol topology map can be based on routing tables for incoming data request from the content servers. The monitoring agent also creates a utilization map (i.e., utilization data file) that indicates a per link data utilization metric. In this regard, the monitoring agent, using the data from the state of the resources in the network, creates a mapping of the bandwidth utilization to the border router interfaces.

Further, the distributed traffic management system can correlate a client IP address (e.g., the IP address of the data request client) with the current load on the peering link serving the data request client. It is possible to localize the peering link route and utilization data to the local traffic management unit where the router resides. As such, traffic management decisions that are local do not require input from a central controller. Other components of the distributed traffic management system further access the traffic management input data to create additional data structures for implementing distributed traffic management functionality.

The controller agent receives the data of the state of the resources (e.g., exterior gateway protocol topology file and utilization file) from the monitoring agent. The controller agent defines, generates and manages local control actions to maintain the bandwidth utilization of the link of the border router interface. The controller agent is configured to control the aggressiveness of the controller or to change a stabilizing set point for network link bandwidth utilization. In particular, the controller agent may reference the state of resources of a border router interface, and using a control algorithm, user input, a combination thereof or other inputs generates a local control action to maintain the bandwidth utilization (e.g., utilization threshold) of the link of the border router interface. Managing the local control actions include the controller agent creating a control output map (e.g., a control output file) of the border router interface to the generated local control actions.

The distributed traffic management system includes a number of content servers that operate to store and communicate data to end-user computing devices. The content servers can be part of a content serving system that includes a content serving agent performing operations to support traffic management. The content servers can be caching servers. Further, the content serving system can optionally include a Domain Name System server that supports DNS-based local control actions as a mechanism for controlling data traffic. The content serving causes execution of local control actions that include, by way of example, throttling, redirection or aborting processing of data requests.

In operation, the content serving agent of the content serving system references the control output file, utilization map and the exterior protocol topology map to execute operations. The content serving agent can reside in one or more content servers or implemented in a distributed manner. The content serving agent instructs the content servers to execute one or more local control actions. In operation, the content serving agent determines the border router interface for an incoming server request. The content serving agent matches the incoming server request's border router interface to a border router interface in the control output file, and applies the corresponding local control action to the incoming server request to maintain the bandwidth utilization of the link of the border router interface monitored by the monitoring agent.

In one embodiment, the content serving agent and not the controller agent accesses utilization data for the router-network-link identifier using the utilization data file. Based on the utilization data and the control output file, the content serving agent determines whether to cause execution of the one or more local control actions associated with processing the data request.

The distributed traffic management system can support different types of local actions. Throttling, redirecting and aborting of incoming server requests are examples of local control actions received to control data traffic congestion or maintain the bandwidth utilization of the link of the border router interface monitored by the monitoring agent. Further, local control actions can be actions taken within the administrative control of the CDN, actions taken within a server within the administrative control of the CDN, actions taken within the administrative control of the traffic management unit, and/or actions taken within a server within the administrative control of the traffic management unit. Local control actions can include actions taken with reference to utilization data attributable to a second auxiliary content server. Accordingly, the distributed traffic management system improves the operations of network devices, in that locally optimal actions support the network devices and obviate performance degradation in transmission of data between the network devices.

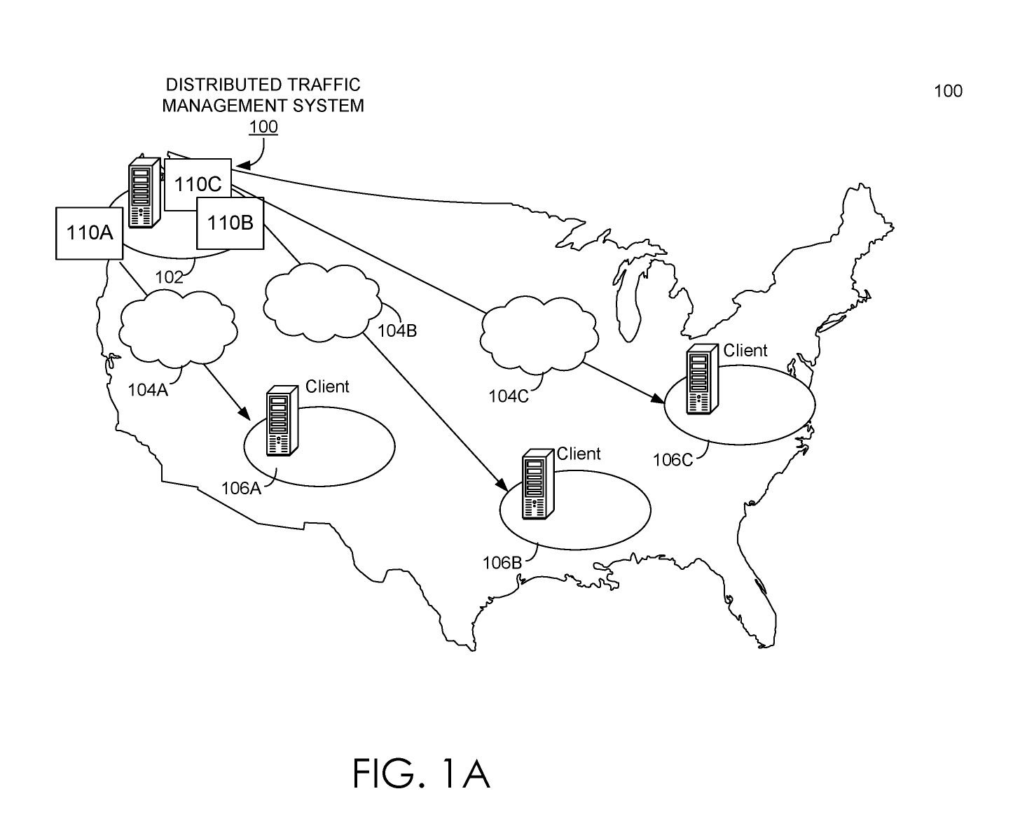

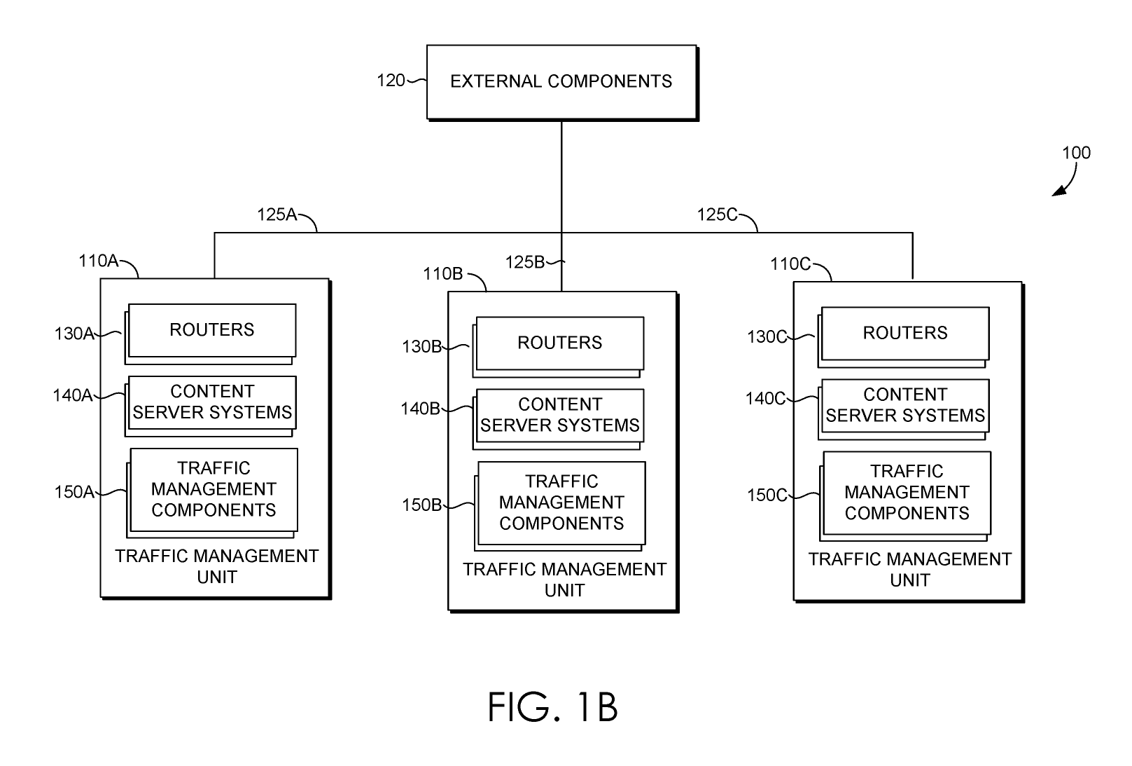

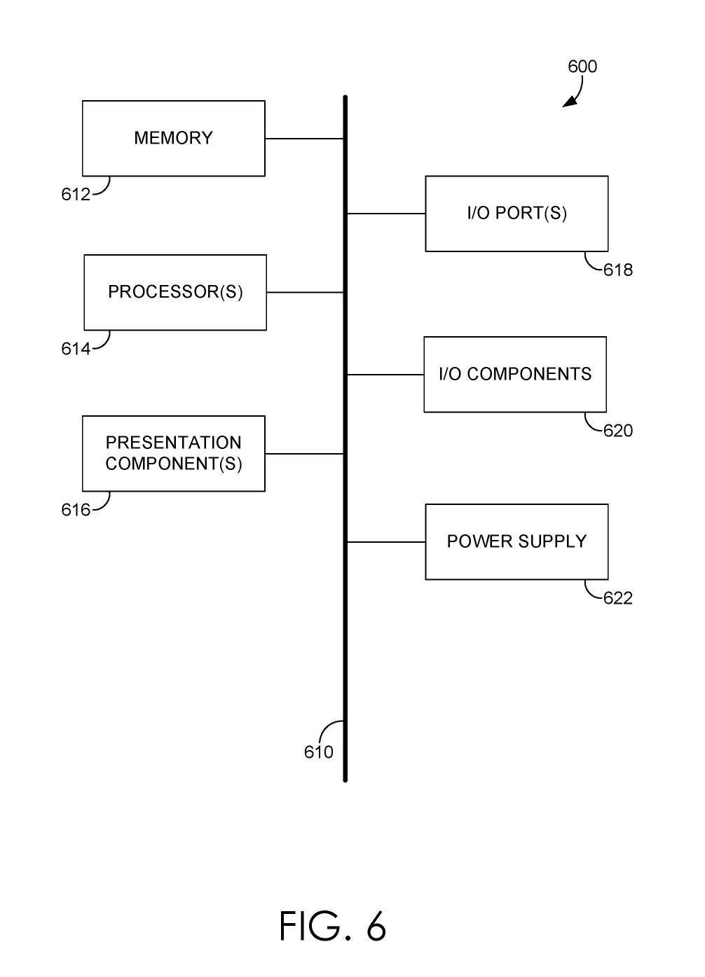

With reference to FIGS. 1A and 1B, embodiments of the present disclosure can be discussed with reference to an exemplary distributed traffic management system 100 operating in a distributed network infrastructure 102 that is an operating environment for implementing functionality described herein of the distributed traffic management system 100. In particular, FIG. 1A illustrates a distributed network infrastructure in communication with multiple Internet Service Providers infrastructures (e.g., ISP 104A, 104B and 104C) to transmit data to clients (e.g., client 106A, 1066 and 106C)—computing devices described herein with reference to FIG. 6.

An ISP can refer to a provider of internet access services for routing and transmitting data between client devices and a network of devices. An ISP can be connected to a distributed network infrastructure via a peering link to a border router of the distributed network infrastructure operating based on a routing protocol (e.g., Border Gateway Protocol (BGP)). A distributed network infrastructure can refer to a distributed computing network system for computing and transmitting data across a plurality of computing devices. A distributed network infrastructure can specifically be a content delivery network of proxy servers that serve content from multiple data centers operating based on distributed networking devices. A data center can include several data center devices (e.g., servers, racks hardware, network devices, etc.) that support providing distributed computing system services. Each data center can include computing clusters (not shown) that operate based on a corresponding cluster manager (e.g., fabric controller) (not shown). The components of a distributed network infrastructure may communicate with each other via a network (not shown), which may include, without limitation, one or more local area networks (LANs) and/or wide area networks (WANs). Such networking environments are commonplace in offices, enterprise-wide computer networks, intranets, and the Internet. The distributed network infrastructure 102 can implement the distributed traffic management system 100 described herein for controlling data traffic and maintaining bandwidth utilization for the distributed network infrastructure 102 via a plurality of distributed traffic management units (e.g., traffic management units 110A, 110B and 110C) as described herein in more detail.

With reference to FIG. 1B, the distributed traffic management system 100 includes several components that support providing the functionality described herein. The distributed traffic management system 100 includes a plurality of traffic management units (e.g., traffic management unit 110A, traffic management unit 110B, and traffic management unit 110C). A traffic management unit can be localized networking construct (e.g., point of presence—PoP) interfacing with internal networking components (e.g., other traffic management units) and external networking components to transmit data to client. External networking components (e.g., external components 120) and refer to different ISPs and components thereof and client devices that a traffic management unit can communicate with to transmit data. A transmit management unit can communicate with one or more ISPs. In particular, a plurality of network links (e.g., network link 125A, 125B, 125C) can connect a traffic management unit to corresponding ISP and other types of external components. Advantageously, each traffic management unit operates to support providing distributed, scalable, and fault tolerance mechanisms for the distributed traffic management system. Each traffic management unit can include routers (e.g., routers 130A, 130B, 130C, content server systems 140A, 140B and 140C and traffic management components 150A, 150B and 150C) (i.e., monitoring agent, controller agent, and content serving agent—not shown). A traffic management unit operates to transmit data from a content server system via routers using links to ISPs and other external components 120. It is contemplated that data is transmitted to a particular ISP through a dedicated network link (e.g., router interface) to that ISP, which can be managed using the traffic management components. A router interface that refers to the combination of a router and a particular network link can be associated with a router-network-link identifier for identifying the combination thereof. In this regard, the distributed traffic management system 100 can support controlling data traffic and maintaining bandwidth utilization based on router-network-links identifiers associated with for the distributed network infrastructure via the traffic management components.

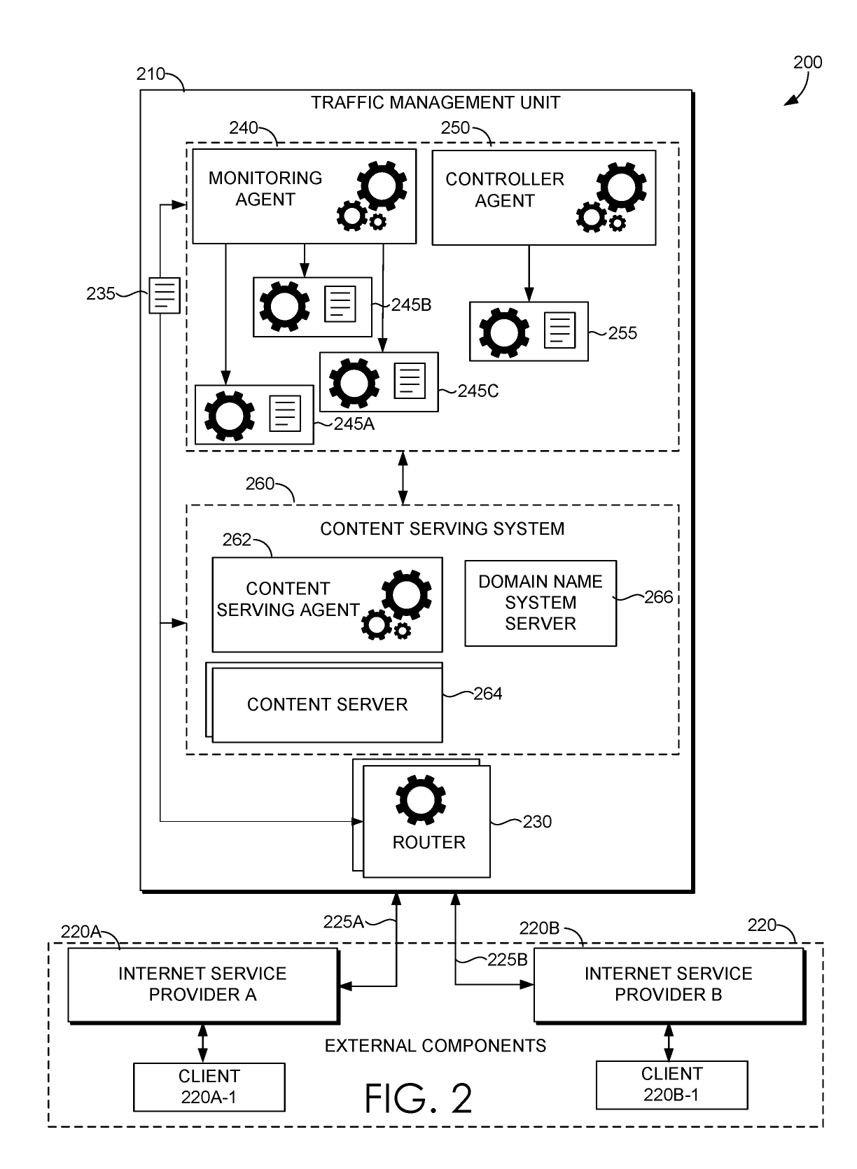

Turning to FIG. 2, FIG. 2 illustrates a block diagram of a distributed traffic management system 200. FIG. 2 includes similar components shown and discussed in FIG. 2 with additional components supporting the functionality of the distributed traffic management system 200. FIG. 2 includes traffic management unit 210 and a plurality of external components 220 (i.e., internet service provider A 220A corresponding to client 220A-1 and internet service provider B 220B corresponding to client 220B-1), network link 225A and network link 225B to ISP A 220A and ISP 220B respectively. The traffic management unit 210 further includes router 230, monitoring agent 240, and controller agent 250, a content serving systems with content serving agent 262, content servers 264 and a Domain Name System (DNS) server 266. In combination, the components of the traffic management system support functionality of the traffic management system 200 as described herein in more detail.

A system, as used herein, refers to any device, process, or service or combination thereof. A system may be implemented using components as hardware, software, firmware, a special-purpose device, or any combination thereof. A system may be integrated into a single device or it may be distributed over multiple devices. The various components of a system may be co-located or distributed. The system may be formed from other systems and components thereof. It should be understood that this and other arrangements described herein are set forth only as examples.

Having identified various components of the distributed network infrastructure 102 and distributed traffic management system 100, it is noted that any number of components may be employed to achieve the desired functionality within the scope of the present disclosure. The various components of FIG. 1A, 1B and FIG. 2 are shown with lines for the sake of clarity. Further, although some components of FIGS. 1A, 1B and FIG. 2 are depicted as single components, the depictions are exemplary in nature and in number and are not to be construed as limiting for all implementations of the present disclosure. The distributed traffic management system 100 functionality can be further described based on the functionality and features of the above-listed components.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

With continued reference to FIG. 2, FIG. 2 includes the monitoring agent 240 that operates as a data collection agent. In particular, the monitoring agent 240 monitors router 230 to identify traffic management input data 235. The router 230 can operate as a border router connecting the traffic management unit 210 to external components 220 including ISP A 220A and ISP B 22B and corresponding clients—client 220A-1 and client 220B-1. The router 230 can be associated with a plurality of network links (e.g., network link 225A and network link 225B). The network link can be a peering link via the router 230 to an external border router; the peering link operates as an interconnection between two administratively separate networks. In this regard, the monitoring agent can retrieve the traffic management input data 235 that include one routing data, utilization data and configuration data associated with the border router.

Routing data can refer to exterior gateway protocol exchange routing and reachability information between networking infrastructures. Routing data of the traffic management input data 235 can be retrieved based on one or more border gateway protocol (BGP) listeners that are configured to monitor exclusively routers within a selected traffic management unit. In this regard, the routing data comprises local routes for routing data from the selected traffic management unit. The routing data of the traffic management input data can be arranged as a table with the following columns: a source router, a destination IP prefix, and a next-hop router.

Utilization data can refer to bandwidth utilization associated with a router and network link. This utilization data can show traffic to and from the distributed network infrastructure via the router and network links to provide metrics on bandwidth consumption. Configuration data can refer to router configurations (e.g., IP addresses, DNS settings, policies and rules configurations, etc.). The configuration data of the traffic management input data can be arranged as a table having the following columns: a source router, an outbound network link and an IP prefix associated with the outbound network link.

The traffic management input data can be retrieved in a variety of different ways. For example, the traffic management input data can be generated based on a Simple Network Management Protocol (SNMP) service, where the SNMP service automatically collects and organizes information for selected routers into routing data tables and configuration data tables. In another example, the traffic management input data is generated based on issuing commands to a link layer discovery protocol of the distributed network infrastructure and parsing responses to generate routing data tables and configuration data tables. Other variations and combinations of traffic management input data 235 and retrieving traffic management input data are contemplated with embodiments described herein.

The monitoring agent 240 further operates to generate an exterior gateway protocol topology file 245A and the utilization data file 245B based on the traffic management input data. The exterior gateway protocol topology file 245A includes a mapping of Internet Protocol (IP) prefixes to router-network-link identifiers. The router-network-links identifiers correspond to router interfaces. IP prefixes are mapped to router-network-link identifiers in that data transmitted using a selected IP prefix is transmitted using an identified router and network link associated with a corresponding router-network-link identifier. The monitoring agent 240 also generates the utilization data file 245B based on utilization data of a plurality of routers (e.g., router 230) The utilization data file includes a mapping of utilization data to corresponding router-network-link identifiers.

In one embodiments, the exterior gateway protocol topology file 245A and the utilization data file are defined as table mappings based on a router interface file 245C. The router interface file 245C, which may be generated using the monitoring agent 240 or another component of the traffic management unit 210 includes a plurality router-network-link identifiers, each router-network-link identifier identifies corresponding router interfaces. A router interface is associated with a router-network-link identifier for a router identifier and an outbound network link identifier based on a single identifier using a hash function.

With continued reference to FIG. 2, FIG. 2 includes the controller agent 250 configured to generate control outputs. The controller agent 250 is configurable to fine tune the utilization of router interfaces and change a stabilizing set point (e.g., predefined bandwidth utilization setting or utilization threshold). As such, generating a control output file can be based on the exterior protocol topology file and the utilization data file. The controller agent ingests the state of resources and generates local control actions. The control output in the control output file is an action aimed at maintaining the utilization of a router interface at a required set point. (e.g., utilization threshold). For example, a control output can be a processing capacity associated with router-network-link identifiers generated using a control feedback mechanism (e.g., proportional-interval-derivative controller—PID controller) at a controller agent to maintain a predetermined or fluctuating utilization threshold. In another example, the control output indicates a percentage of incoming Hyper Text Transfer Protocol (HTTP) traffic to be aborted to maintain the utilization threshold. In another example, the control output indicates a number of Domain Name System (DNS) queries to be redirected away from a collocated DNS server to maintain the utilization threshold.

Generating a control output file 255 can be based on only the exterior protocol topology file. The control output file includes a mapping of router-network-link identifiers to one or more local actions associated with control outputs to support maintaining a utilization threshold for router interfaces processing data requests. In this implementation, the control output file 255 is merely a reference of one or more local control actions. And as discussed below in more detail, a content serving agent (e.g., content serving agent 262) can further reference the utilization data file and based on the utilization data breaching a utilization threshold, a local action associated with breaching the utilization threshold can be accessed and caused to be executed. Other variations and combinations of generating control output files and control outputs are contemplated with embodiments described herein.

With continued reference to FIG. 2, FIG. 2 includes the content serving agent 262 configured to process data requests and cause execution of one or more local control actions associated with processing the data request. The content serving agent accesses a data request from a content server (e.g., content server 264) associated with the content serving agent 262 via the content serving system 260. The content serving agent 262 determines, using an IP address associated with the data request, that the data request is associated with a corresponding router interface based on referencing the exterior protocol topology file. The content serving agent 262 identifies a router-network-link identifier and one or more local control actions for the data request based on accessing the control output file 255. The control output file 255 includes a mapping of router-network-link identifiers to one or more local control actions. Based on the control output file 255, the content serving agent 262 can determine whether to cause execution of the one or more local control actions associated with processing the data request. The local control action can be executed via different components in the distributed traffic management system. For example, a DNS server (e.g., DNS server 266) can be directed to execute actions including throttling, redirecting or aborting actions for processing of data requests. The content serving agent 262, the router 230, and the content server 264 can each operate to execute corresponding local control actions.

As discussed, the content serving agent 262 can further accessing utilization data for the router-network-link identifier using the utilization data file, the utilization data file is generated based on utilization data of a plurality of routers. The utilization data file includes a mapping of utilization data to corresponding router-network-link identifiers. The content serving agent 262 can be configured to determine that the utilization data meets a utilization threshold associated with executing one or more local control actions and thus cause execution of the one or more local control actions associated with processing the data request based on the utilization data and the one or more local control actions of the router-network-link identifier.

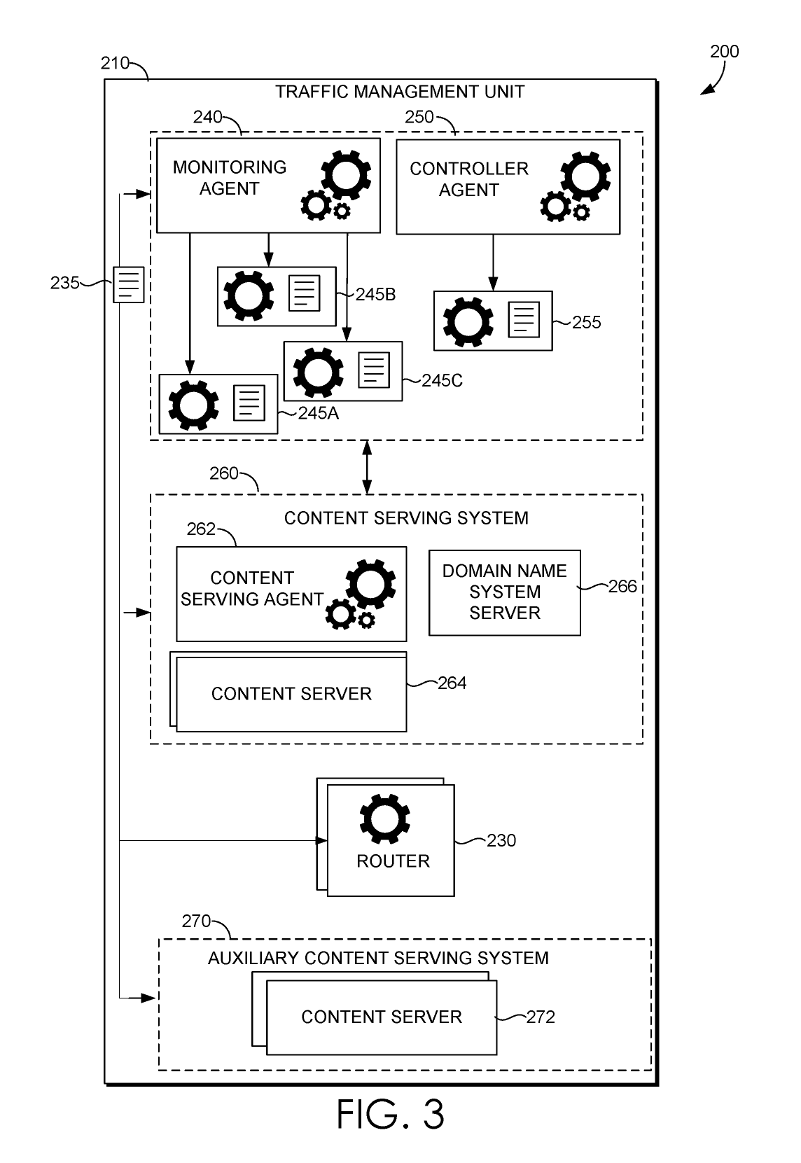

With reference to FIG. 3, FIG. 3 includes similar components shown and discussed in FIG. 2 with a second content server in the auxiliary content serving system that is not directly associated with traffic management components or not part of the local environment. By way of example, the router 230 may operate to serve data traffic that is not originated from the content serving system 260 but instead from auxiliary content serving system 270 having content server 272 (i.e., a second content server). This additional data traffic at router 230 might increase the load of the router 230 and the local environment may not be able to reduce the data traffic simply by modifying its own response. Traffic management input data for the first content server and the second content server can identified based on monitoring the router in the router-network-link identifier. In this regard, the controller agent and/or content serving agents can perform other types of mitigating actions.

It is contemplated that the control output file 255 can include one or more local control actions, the one or more local control actions are based on utilization data attributable to the first content server and the second content server. If the second content server is not under direct control, the one or more local actions can be an informational communication to an administrator of the second content server. A first set of the one or more local actions can be executed with reference to the first content server and a second set of the one or more local actions are executed with reference to the second content server.

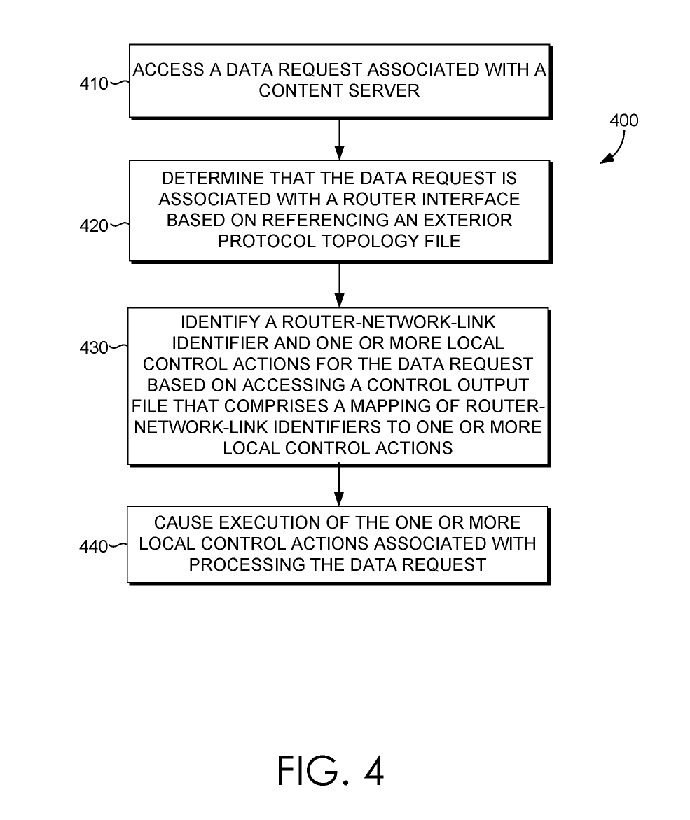

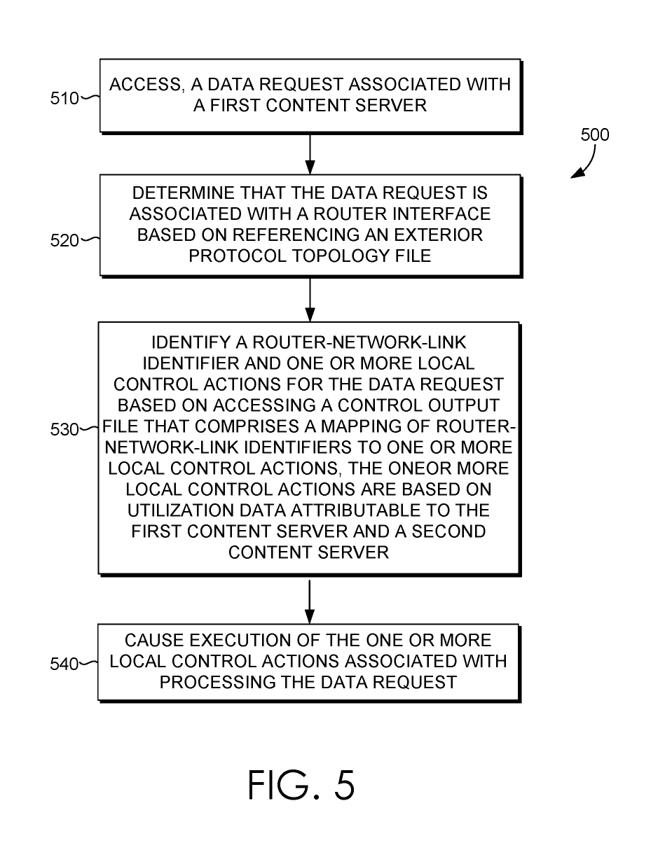

Turning now to FIGS. 4 and 5, a plurality of flow diagrams are provided illustrating methods for implementing distributed traffic management. The methods can be performed using the distributed traffic management system 100 described herein. In embodiments, one or more computer storage media having computer-executable instructions embodied thereon that, when executed, by one or more processors can cause the one or more processors to perform the methods in the traffic management system in the distributed network infrastructure. The distributed network infrastructure includes a plurality of traffic management units; where each traffic management unit manages data traffic operations for a portion of a distributed network infrastructure.

With reference to FIG. 4, a flow diagram is provided that illustrates a method 400 for providing distributed traffic management. Initially at block 410, a data request associated with a content server is accessed using a content serving agent. At block 420, based on referencing an exterior protocol topology file, a determination is made that the data request is associated with a router interface. The exterior gateway protocol topology file includes a mapping of Internet Protocol (IP) prefixes to corresponding router-network-link identifiers, the router-network-links identifiers correspond to router interfaces. At block 430, a router-network-link identifier and one or more local control actions are identified for the data request, based on accessing the control output file that comprises a mapping between the router-network-link identifier and the one or more local control actions. At block 440, execution of the one or more local control actions associated with processing the data request is caused.

With reference to FIG. 5, a flow diagram is provided that illustrates a method 500 for providing distributed traffic management. Initially at block 510, a data request associated with a first content server is accessed using a content serving agent. At block 520, based on referencing an exterior protocol topology file, a determination is made that the data request is associated with a router interface. The exterior gateway protocol topology file includes a mapping of Internet Protocol (IP) prefixes to corresponding router-network-link identifiers. The router-network-links identifiers correspond to router interfaces. At block 530, a router-network link identifier and one or more local control actions are identified for the data request, based on accessing the control output file that includes a mapping between the router-network link identifier and the one or more local control actions. The one or more local control actions are based on utilization data attributable to the first content server and a second content server. At block 540, execution of the one or more local control actions associated with processing the data request is caused.

With reference to the distributed traffic management system, embodiments described herein operate to collect, organize and process traffic management input data (e.g., routing data, utilization data and configuration data of border routers) from border routers corresponding to a specific traffic management unit to take appropriate local control actions. The local control actions support maintaining the bandwidth utilization of the network links associated with the border routers. The traffic management system components refer to integrated components for distributed traffic management. The integrated components refer to the hardware architecture and software framework that support distributed traffic management functionality using distributed the traffic management system 100. The hardware architecture refers to physical components and interrelationships thereof and the software framework refers to software providing functionality that can be implemented with hardware embodied on a device. The end-to-end software-based traffic management system can operate within the traffic management system components to operate computer hardware to provide traffic management system functionality. As such, the traffic management system components can manage resources and provide services for the traffic management system functionality. Any other variations and combinations thereof are contemplated with embodiments of the present invention.

By way of example, the traffic management system can include an API library that includes specifications for routines, data structures, object classes, and variables may support the interaction between the hardware architecture of the components and the software framework of the traffic management system. These APIs include configuration specifications for the traffic management system such that the different components therein can communicate with each other in the traffic management system, as described herein.

Having briefly described an overview of embodiments of the present invention, an exemplary operating environment in which embodiments of the present invention may be implemented is described below in order to provide a general context for various aspects of the present invention. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output ports 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters” using communication media described herein. Also, the word “initiating” has the same broad meaning as the word “executing or “instructing” where the corresponding action can be performed to completion or interrupted based on an occurrence of another action. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the traffic management system and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A system for implementing distributed traffic management in distributed network infrastructures, the system comprising:
a plurality of traffic management units, wherein each traffic management unit manages data traffic operations for a portion of a distributed network infrastructure, wherein each traffic management unit of the plurality of traffic management units includes:
a monitoring agent configured to:
monitor a router interface to identify traffic management input data, wherein the router interface comprises a border router and a network link, wherein the traffic management input data comprises one or more of the following: routing data, utilization data and configuration data associated with the border router;
generate an exterior gateway protocol topology file based on the traffic management input data, wherein the exterior gateway protocol topology file comprises a mapping of Internet Protocol (IP) prefixes to router-network-link identifiers, wherein router-network-link identifiers correspond to router interfaces; and
generate a utilization data file based on the traffic management input data, wherein the utilization data file comprises a mapping of utilization data to router-network-link identifiers;
a controller agent configured to:
generate a control output file using the exterior protocol topology file and the utilization data file, wherein the control output file comprises a mapping of router-network-link identifiers to one or more local actions associated with control outputs to support maintaining a utilization threshold for router interfaces processing data requests; and
a content serving agent configured to:
access a data request associated with a content server;
determine, using an IP address associated with the data request, that the data request is associated with the router interface based on referencing the exterior protocol topology file;
identify a router-network-link identifier and one or more local control actions for the data request based on accessing the control output file that comprises a mapping of router-network-link identifiers to one or more local control actions; and
based on the control output file, determine whether to cause execution of the one or more local control actions associated with processing the data request.

2. The system of claim 1, wherein IP prefixes are mapped to router-network-link identifiers in that data transmitted using a selected IP prefix is transmitted using an identified router and network link associated with a corresponding router-network-link identifier, wherein the network link is a peering link via the border router to an external border router, wherein the peering link operates as an interconnection between two administratively separate networks.

3. The system of claim 1, wherein exterior gateway protocol topology file and the utilization data file are defined as table mappings based on a router interface file comprising a plurality router-network-link identifiers each router-network-link identifier identifies corresponding router interfaces comprising a router identifier and an outbound network link identifier defined as a single identifier using a hash function.

4. The system of claim 1, wherein the routing data of the traffic management input data is received based on one or more border gateway protocol (BGP) listeners that are configured to monitor exclusively routers within a selected traffic management unit such that the routing data comprises local routes for routing data from the selected traffic management unit.

5. The system of claim 1, wherein the routing data of the traffic management input data comprises a source router, a destination IP prefix, and a next-hop router.

6. The system of claim 1, wherein the configuration data of the traffic management input data comprises a source router, an outbound network link and an IP prefix associated with the outbound network link.

7. The system of claim 1, wherein the traffic management input data is generated based on one of the following:
a Simple Network Management Protocol (SNMP) service, wherein the SNMP service automatically collects and organizes information for selected routers into routing data tables and configuration data tables; or
issuing commands to a link layer discovery protocol of the distributed network infrastructure and parsing responses to generate routing data tables and configuration data tables.

8. The system of claim 1, wherein the traffic management input data is for a first content server and a second content server is identified based on monitoring the router interface, wherein the one or more local control actions are based on utilization data attributable to the first content server and the second content server; and wherein the second content server is not under direct control of the distributed traffic management such that the one or more local actions comprises an informational communication to an administrator of the second content server.

9. One or more hardware computer storage media storing computer-useable instructions that, when used by one or more computing devices, cause the one or more computing devices to perform a method for distributed traffic management, the method comprising:
accessing a data request associated with a content server, wherein the content server is associated with a traffic management unit of a distributed network infrastructure, the distributed network infrastructure having a plurality of traffic management units, wherein each traffic management unit manages data traffic operations for a portion of the distributed network infrastructure;
determining that the data request is associated with a router interface based on referencing an exterior protocol topology file, wherein the exterior gateway protocol topology file comprises a mapping of Internet Protocol (IP) prefixes to corresponding router-network-link identifiers, wherein router-network-links identifiers correspond to router interfaces;
identifying a router-network-link identifier and one or more local control actions for the data request based on accessing the control output file that comprises a mapping between the router-network-link identifier and the one or more local control actions; and
causing execution of the one or more local control actions associated with processing the data request.

10. The media of claim 9, wherein IP prefixes are mapped to router-network-link identifiers in that data transmitted using the IP prefix is transmitted using an identified router and network link associated with a corresponding router-network-link identifier, wherein router-network-link identifiers identify corresponding router interfaces comprising a router identifier and network link identifier based on a single identifier using a hash function.

11. The media of claim 9, wherein the control output file is generated using the exterior protocol topology file and the utilization data file, wherein the control output file comprises a mapping of router-network-link identifiers to one or more local actions associated with control outputs to support maintaining a utilization threshold for router interfaces processing data requests.

12. The media of claim 9, wherein a control output is a processing capacity associated with router-network-link identifiers generated using a control feedback mechanism at a controller agent to support maintaining a utilization threshold associated with corresponding router-network-link identifiers processing data requests.

13. The media of claim 12, wherein the control output indicates a percentage of incoming Hyper Text Transfer Protocol (HTTP) traffic to be aborted to maintain the utilization threshold.

14. The media of claim 12, wherein the control output indicates a number of Domain Name System (DNS) queries to be redirected away from a collocated DNS server to maintain the utilization threshold.

15. The media of claim 9, further comprising:
accessing utilization data for the router-network-link identifier using the utilization data file, wherein the utilization data file is generated based on utilization data of a plurality of routers, wherein the utilization data file comprises a mapping of utilization data to corresponding router-network-link identifiers; and
determining that the utilization data is a utilization threshold associated with executing one or more local control actions, wherein causing execution of the one or more local control actions associated with processing the data request is based on the utilization data and the one or more local control actions.

16. A computer-implemented method for providing distributed traffic management, the method comprising:
accessing a data request associated with a first content server associated with the content serving agent, wherein the first content server is associated with a traffic management unit of a distributed network infrastructure, the distributed network infrastructure having a plurality of traffic management units, wherein each traffic management unit manages data traffic operations for a portion of the distributed network infrastructure;
determining that the data request is associated with a router interface based on referencing an exterior protocol topology file, wherein the exterior gateway protocol topology file comprises a mapping of Internet Protocol (IP) prefixes to corresponding router-network-link identifiers, wherein router-network-links identifiers correspond to router interfaces;
identifying a router-network link identifier and one or more local control actions for the data request based on accessing the control output file that comprises a mapping between the router-network link identifier and the one or more local control actions, wherein the one or more local control actions are based on utilization data attributable to the first content server and a second content server; and
causing execution of the one or more local control actions associated with transmitting the data request.

17. The method of claim 16, wherein the second content server is not under direct control of the distributed traffic management such that the one or more local actions comprises an informational communication to an administrator of the second content server.

18. The method of claim 16, wherein a first set of the one or more local actions are executed with reference to the first content server and a second set of the one or more local actions are executed with reference to the second content server.

19. The method of claim 16, wherein the first set of the one or more local actions include control actions directed to throttling, redirecting or aborting processing of data requests.

20. The method of claim 16, wherein traffic management input data for the first content server and the second content server is identified based on monitoring the router in the router-network-link identifier, wherein the traffic management input data comprises one or more of the following: routing data, utilization data and configuration data associated with the border router
